(19) United States
(12) Patent Application Publication
(10) Pub. No.: US 2013/0345849 A1
(43) Pub. Date: Dec. 26, 2013

(54) LASER LOCATION CONFIRMATION APPARATUS FOR TOOLS

(71) Applicants: LEON DRASOVEAN, London (CA); MOE HAJAR, London (CA)

(72) Inventors: LEON DRASOVEAN, London (CA); MOE HAJAR, London (CA)

(73) Assignee: Toyota Motor Engineering & Manufacturing North America, Inc., Erlanger, KY (US)

(21) Appl. No.: 13/532,939

(22) Filed: Jun. 26, 2012

(51) Int. Cl. G05B 19/18

(52) U.S. Cl. 700/117

(57) ABSTRACT

A method and apparatus for confirming identification of a tool position relative to a workpiece and selecting the tool operating program associated with the position of the tool. A laser location confirmation apparatus is mounted on a tool and measures the distance between the tool or laser source and a surface feature adjacent to the tool, after the tool is engaged with a workpiece joint. When a distance match is made by a laser controller with one of a plurality of prestored reference distances identified with each different work operation or joint, the proper tool operating program is selected and activated.

### BACKGROUND

The present invention relates, in general, to tools and, more particularly to automatic tools running a stored operating program.

Tools are used to assemble most machines, vehicles and other apparatus. The common type of tool used in assembly of various apparatus applies or tightens a fastener to join two or more work pieces together.

One such tool is a nutrunner which executes a control program, when the nutrunner is activated by an operator, programmed robot, or other control apparatus, to tighten a nut on a threaded fastener according to the pre-programmed tightening speed, maximum torque, torque angle or other parameters required for that particular fastener or joint.

Nutrunners coupled to a controller which is capable of storing and supplying control values to the nutrunner to execute a number of different tightening and torque application programs are used in many assembly operations, and, in particular, vehicle assembly operations. However, in the case of manually operated nutrunners, it is up to the operator to identify the particular joint and then select the appropriate tightening or torque program. This leaves an opportunity for judgment errors on part of the operator which could result in an incomplete torque of the nut or over tightening of the nut, the wrong maximum torque applied to the nut or joint or the torque angle of the nut, stripping of the threads in the nut and bolt, etc.

In an attempt to address defects caused by operator error, a smart arm apparatus has been designed for use in fixture tools having assist arms which support the weight and the forces generated by the nutrunner by a movable mechanical structure. The assist arm is designed to allow free movement of the nutrunner in multiple directions by using a combination of articulated arms with rotational joints and/or linear bearings. This combination of articulated arms can allow up to six degrees of freedom of movement of the nutrunner.

The position of the nutrunner in free space can be determined by placing rotational or linear encoders on the joints or linear bearings of the articulated arms of the assist arm and then using the encoder values to calculate the position coordinates via a positioning controller. This insures that the location of the nutrunner with respect to a particular joint is known before the nutrunner is activated. This also insures that the proper tightening or torque program is selected for the nutrunner for the joint currently engaged by the nutrunner.

The assist arm technology can be used only if the assist arm carrying the nutrunner is in a stationary position relative to the vehicle which is moving past the assist arm station in the assembly line. Typically, the assist arm is installed on a dolly that is mechanically attached to each moving carrier as each carrier moves past the nutrunner work station. This allows the origin of coordinates to be located at the same location relative to the vehicle for the proper selection of the nutrunner program for each joint.

However, there are applications where, due to the design of the assist arm, the assist arm is fixedly mounted to the assembly plant floor instead of on a dolly movable with the vehicle. In this application, the encoder positions would continuously change as the operator is following the vehicle in the process operation, thereby making the determination of the the coordinates of the position of the nutrunner relative to a joint on the vehicle impossible. This prevents the confirmation of the joint location for the application of the proper nutrunner program for that identified joint.

It would be desirable to provide an apparatus and method for confirming joint location in all assembly applications to insure that the proper joint tightening program is selected for each different joint.

### SUMMARY

A method of selecting a stored tool operating program for a tool coupled to a tool controller and having a work piece engagement portion includes the steps of:
engaging the work piece engagement member of the tool with the workpiece;
measuring, by a distance measurement device carried on the tool, a distance dimension between the distance measurement device and a surface feature dimensionally fixed with respect to the workpiece;
comparing, by a distance measurement apparatus controller, the measured distance dimension with a reference distance dimension;
transmitting by the distance measurement apparatus controller a match signal to a tool controller when the measured distance dimension equals one of the reference distance dimensions; and
selecting, by the tool controller, a tool operating program associated with the distance measurement apparatus output.

The method can include mounting the distance measurement device on the tool.

An improvement includes forming the distance measurement apparatus as a laser sensor capable of emitting a laser beam from a laser source and determining a distance between the laser source and the surface feature using the laser beam.

The improvement can include adjustably mounting the laser on the tool.

The tool can be provided as a nutrunner having selectable prestored torque programs, each associated with an identifiable joint on a workpiece. In this aspect, the method includes prestoring one joint location ID with a nutrunner torque program associated with the one joint, moving the nutrunner into an operating position engaged with the one joint, and identifying the joint location ID by matching a dimension from a laser sensor to a surface feature adjacent to the joint. When a dimensional match is determined, a nutrunner torque program prestored for the one joint is selected for operation of the nutrunner.

An apparatus is disclosed for authorizing selection of one of a plurality of distinct tool operating programs each associated with one of a plurality of distinct tool operations on a workpiece includes a distance measurement sensor carried on the tool. The distance measurement sensor is capable of measuring a distance dimension between the distance measurement sensor and a surface feature adjacent to the location of the tool operation on the work piece. The distance measurement sensor outputs a signal when the measured distance dimension matches a reference distance dimension prestored in the laser sensor in the distance measurement apparatus. The tool controller, upon receiving the output signal from the distance measurement sensor, selects the one of the plurality of distinct tool operating programs associated with the one of the plurality of distinct tool operations on the work piece associated with the distance measurement for operating the tool according to the selected one tool operating program.

The apparatus can include holder mountable on the tool. The distance measurement sensor can be mounted on the holder. The distance measurement sensor can be adjustably mounted on the holder.

The distance measurement sensor can be a laser distance sensor.

The tool can be a nutrunner.

### BRIEF DESCRIPTION OF THE DRAWING

The various features, advantages and other uses of the present invention will become more apparent by referring to the following detailed description drawing in which:

FIG. 1 is a side elevational view of a laser location confirmation apparatus for a tool;

FIG. 2 is a front elevational view of a nutrunner and nutrunner controller shown in FIG. 1 as an example of a tool;

FIG. 3 is a pictorial block representation of the tool, tool controller and electrical controls of the laser location confirmation apparatus;

FIG. 4 is a perspective view of a laser location apparatus mounted on a nutrunner, as shown in FIGS. 1, 2, and 3;

FIG. 5 is a perspective view showing the use of the apparatus in operating a nutrunner on a first joint;

FIG. 6 is an electrical diagram showing the interface signals between the laser location confirmation apparatus and the tool;

FIG. 7 is an enlarged, perspective view showing the first joint depicted generally in FIG. 5;

FIG. 8 is a perspective view of the use of the laser location confirmation apparatus with the nutrunner to tighten a second joint; and

FIG. 9 is an enlarged perspective view of the second joint.

### DETAILED DESCRIPTION

The following description is a laser location confirmation apparatus for use with an automatic tool which confirms the location of the tool with respect to a joint or other location on a workpiece where the tool is to perform an operation, such as tightening a nut or bolt, drilling a hole etc. The laser location confirmation apparatus identifies the location of the tool at the joint and then sends a signal to enable the tool controller to select the proper operating program for that particular tool location or tool operation.

By way of example only, the following description of the laser location confirmation apparatus uses a nutrunner operating several different control programs to tighten bolts in an automotive vehicle where at least two of the bolts require different tightening parameters. It will be understood that the laser location confirmation apparatus can be used with different tools for different tool operations, in addition to the following description of the use of the laser location confirmation apparatus with an automated nutrunner.

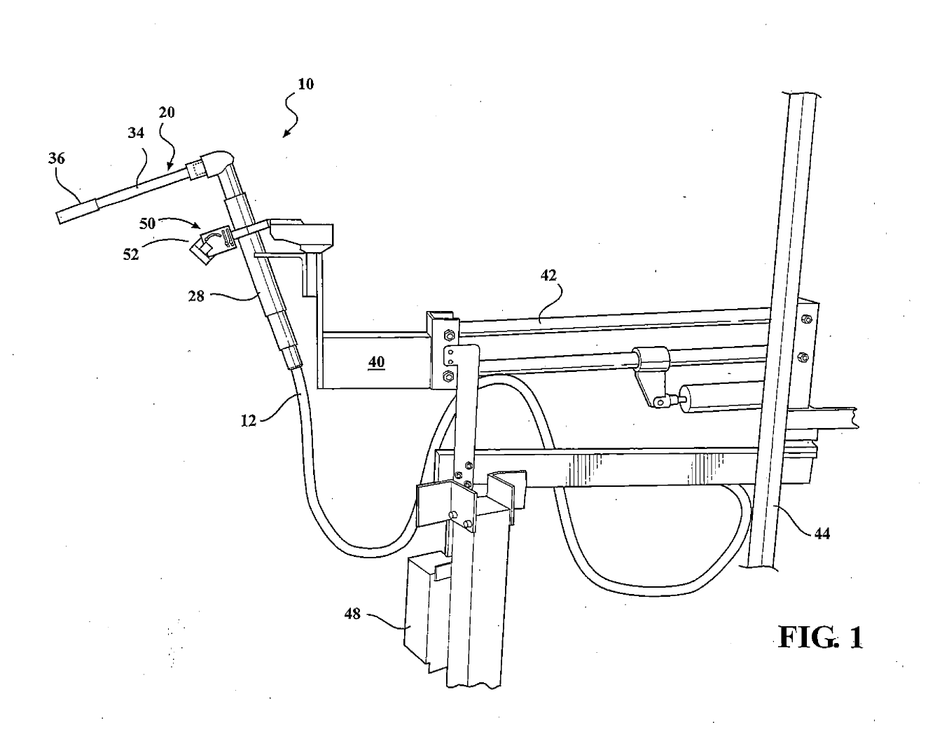

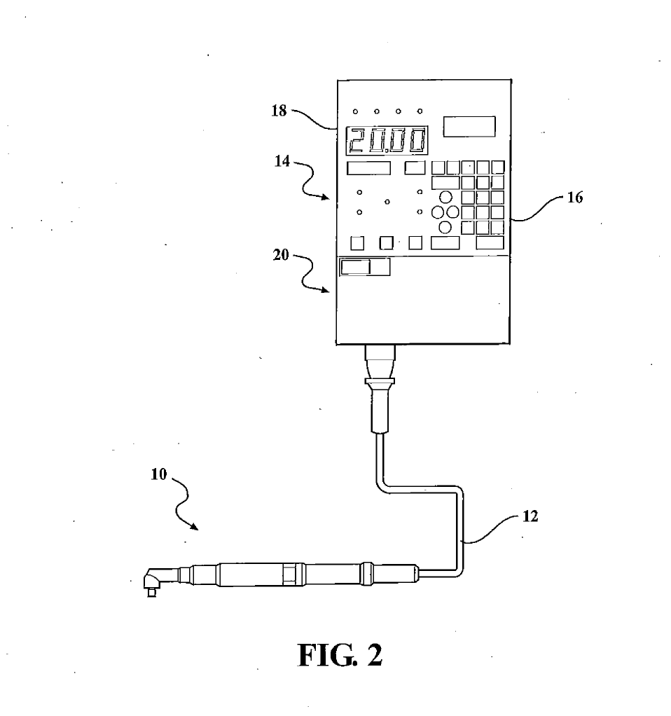

Referring now to FIGS. 1-3, there is depicted a tool which, by example only, is a nutrunner 10. The nutrunner 10 is coupled by a power cable 12 to a tool controller 14. The tool controller 14 may include a central processing unit, such as a microprocessor or microcontroller, which executes a stored program containing individually selectable program parameters for operating the nutrunner 10. The programs may be entered into the memory of the tool controller 14 via input push buttons 16 with the assistance of a display 18 on the face of the junction box 20 of the tool controller 14 or via computer software interface.

The memory of the tool controller 14 stores a number of variables in each program associated with the operation of the tool or nutrunner 10. Such variables can include, for example, the rotation speed, the torque, the torque angle, tool advance speed, and other variables, such as depth of cut, etc., for other types of tools. These variables are stored in the memory of the controller 14 and are individually selectable to meet the requirements of a particular tool operation.

In the assembly of automotive vehicles, a number of different joints using bolts are used to join vehicle components together. The joints frequently have different assembly variables, such as final torque, torque angle, advance speed, etc. Thus, for proper assembly of the vehicle and for safe and reliable operation of the vehicle, it is important that each joint or work operation be completed correctly.

In the present example of the nutrunner 10 used to tighten a number of different bolts on an automotive vehicle, the tool controller 14 operates to provide appropriate control signals via the cable 12 to the nutrunner 10 for the identified joint or work operation.

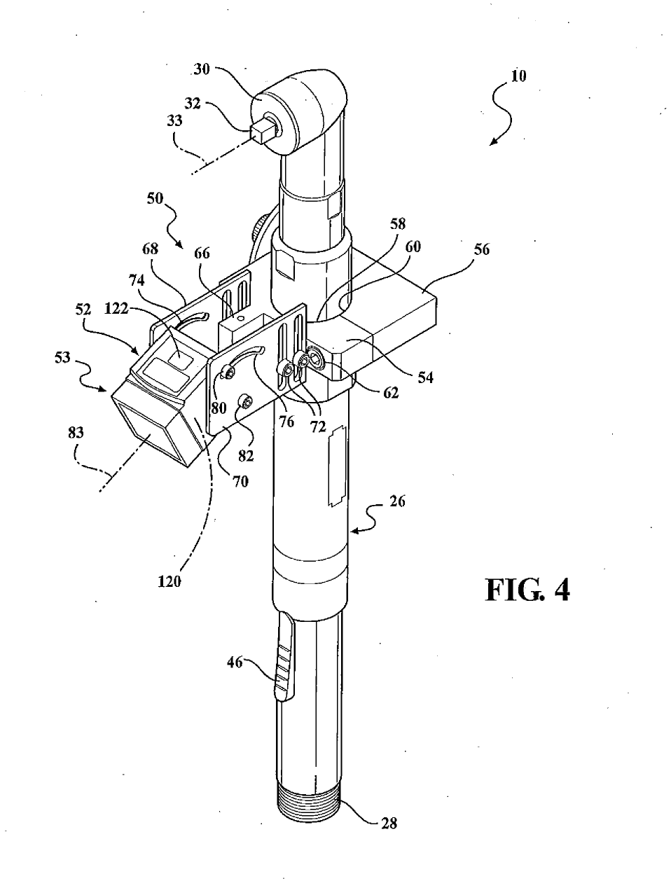

As shown by example in FIGS. 1 and 4, the nutrunner 10 includes an elongated, generally cylindrical shaped body 26 having a first end 28 which is connectible to the power cable 12 and an opposed second end 30 which carries a rotatable socket head 32.

As shown generally in FIG. 1, an elongated socket extension 34 is coupled to the socket head 32 and terminates in a socket 36 sized to engage a particular size bolt on the vehicle.

It will be understood, however, that any size socket or different sockets, each associated with different sized bolts or joints on a vehicle may be employed with a single nutrunner 10.

As shown by way of example only in FIG. 1, an optional assist arm assembly 40 is mounted to the assembly plant floor for supporting the tool or nutrunner 10 in the desired position and to reduce fatigue of the tool operator during operation of the nutrunner 10. The assist arm 40 includes an extensible arm linkage 42 mounted on a stand 44 and attached to the nutrunner 10 to support and allow three dimensional or six plane movement of the nutrunner 10.

The power cable 12 extends from the nutrunner 10 to attachments on a frame 44 of the assist arm 40 and then to the tool controller junction box 20 as shown in FIG. 1.

A separate junction box 48 is also mounted on the frame 44 to enclose the wiring terminals for a distance measurement apparatus or sensor, such as a laser location confirmation apparatus described hereafter.

A trigger or activation switch 46 is mounted on the body 26 of the nutrunner 10 and is coupled to the conductors in the power cable 12 for activating the nutrunner 10.

Referring now to FIG. 4, a holder 50 is provided to fixedly, yet adjustably couple a distance measurement sensor, hereafter referred to as a laser location confirmation apparatus 52 to the body 26 of the nutrunner 10.

By way of example only, the holder 50 includes front and rear split connector plates 54 and 56, respectively. Each of the plates 54 and 56, which have a general linear configuration, have complimentary semicircular openings along a mating side edge. The semicircular openings 58 and 60 surround the body 26 of the nutrunner 10 and secure the connecting plates 54 and 56 to the body of the nutrunner 26 when mounting screws extend through the plates 54 and 56. Only one of the mounting fasteners 62 is shown in FIG. 4.

A pair of spaced legs, 66, only one of which is shown in FIG. 4, project from an opposite side of the front connector plate 54 from the side edge carrying the semicircular opening 58. The legs 66 provide an attachment support for a pair of pivot plates 68 and 70 which are attached to the legs 66 by bolts 72.

A slot 74 and 76 is formed in each of the pivot plates 68 and 70, respectively. By way of example only, each slot 74 and 76 has an arcuate shape. A pair of fasteners, with only one fastener 80 shown in FIG. 4, extends through the slots 74 and 76 into the body or housing 53 of the laser location confirmation apparatus 52. The second pair of fasteners 82 with only one fastener 82 being shown in FIG. 4, are provided through a separate opening in each pivot plate 74 and 76 and also engage in a lower portion of the housing 53 of the laser location confirmation apparatus 52. The arrangement of the fasteners 80, the slots 74 and 76 and the fixed fasteners 82 allow the orientation of the aiming axis 83 of the laser location confirmation apparatus 52 to be adjusted relative to the plane of the connecting plates 54 and 56 of the holder 50 and relative to the axis of rotation of the socket 32 of the nutrunner 10.

By way of example only, the housing 53 is shown at a nonparallel, acute angle relative to an axis of rotation 33 of the socket end 32. To achieve this angular orientation or to adjust the aiming axis 83 of a laser source 84 in the laser location confirmation apparatus 52 to a different angle, the fasteners 80 and 82 are first loosened. The housing 32 is then adjusted until the axis 83 is at the desired angle relative to the longitudinal axis through the body 26 of the nutrunner 10 or to the axis of rotation 33 of the socket head 32. The fasteners 80 and 82 are then tightening to fix the housing 53 into the desired position.

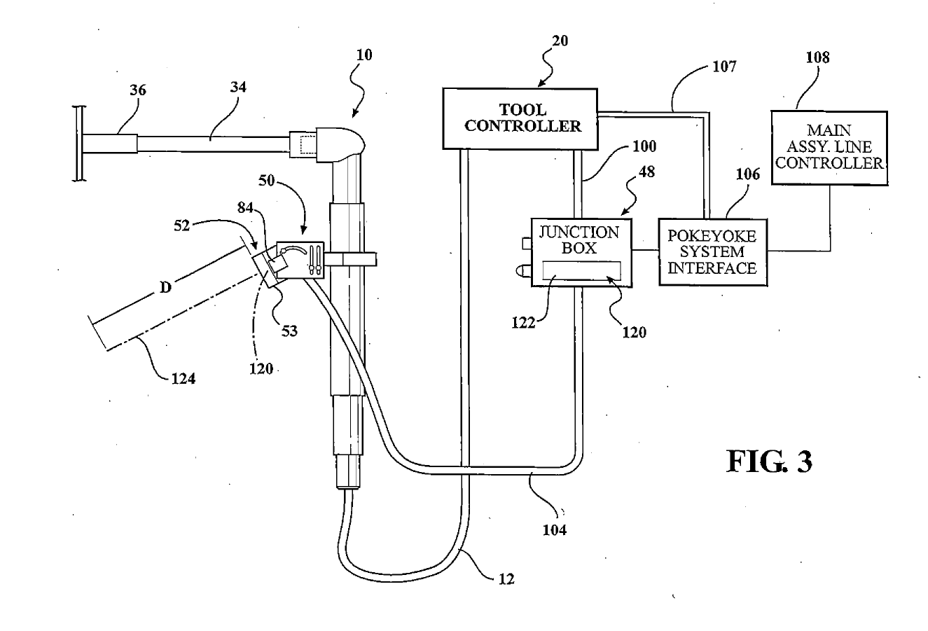

Referring briefly to FIG. 3, as described above, the power cable 12 from the nutrunner 10 is coupled to the tool controller junction box 20. A cable 100 also runs from the tool controller 20 to the junction box 48 with the communication of electrical signals between the laser location confirmation apparatus 52 via cable or a plurality of individual conductors.

The tool controller junction box 20 is also coupled to the assembly plant Pokayoke system interface 106 via cable 107 to transmit go and no go signals from the tool controller 14 respectively indicative of a proper assembly operation or a non-proper assembly operation. The Pokayoke system interface 106 is coupled to the main assembly line controller 108 and is capable of sending a signal of stopping the main assembly line in the event of a no good assembly operation by the nutrunner 10.

A laser controller 120 is mounted inside the housing 53. A display 122 may be coupled to the laser controller 120 and visible from the housing 53 to display distance values and other operating parameters.

The laser controller 120 executes a program stored in a memory accessible by the laser controller 120. The program stores distance information associated with each different work operation, such as the tightening of the bolts or joints in the following description. The stored distances or dimensions are referred to as reference distances.

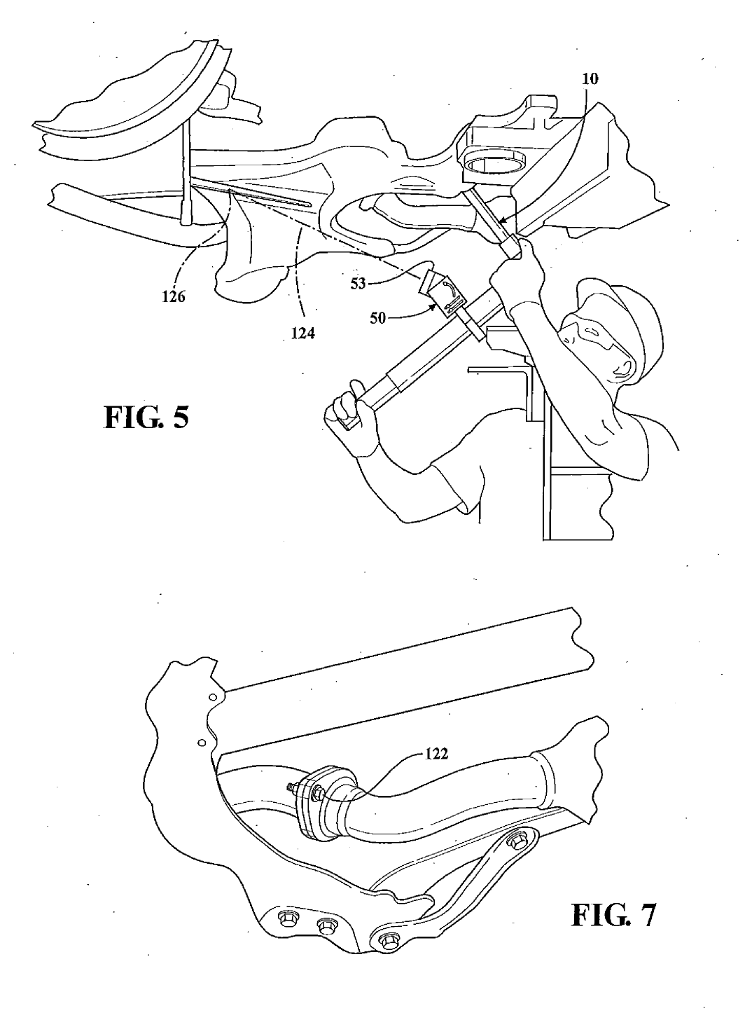

In operation, a vehicle will advance into a work station as shown in FIGS. 5 and 7. The Pokayoke system 106 requests the tool controller 20 to run the first tool operation program PSET#1 which corresponds to the first joint 122 to be tightened in the work station process. The operator then engages the socket 36 of the nutrunner 10 with the nut 122 as shown in FIG. 5 and depresses the trigger 46 on the nutrunner 10 to start the tightening sequence.

The laser in the housing 53 attached to the nutrunner 10 continuously emits the laser beam 124 and computes the distance to the surface feature selected to correspond to joint #1. In the example shown in FIG. 5, the surface feature is the front suspension member of the vehicle which is located in close proximity to joint #1. The laser beam 124 is reflected from the surface feature 126 back to the laser housing 53 where the laser controller 120 computes the distance to the surface feature 126.

When the distance value computed by the laser controller 120 falls inside the range preprogrammed for the joint #1 location, the laser output OU1 is generated by the laser controller 120 and transmitted to the tool controller 20 where ladder logic is provided to control the operation of the nutrunner 10. This sequence confirms the placement of a nutrunner 10 on the proper joint 122.

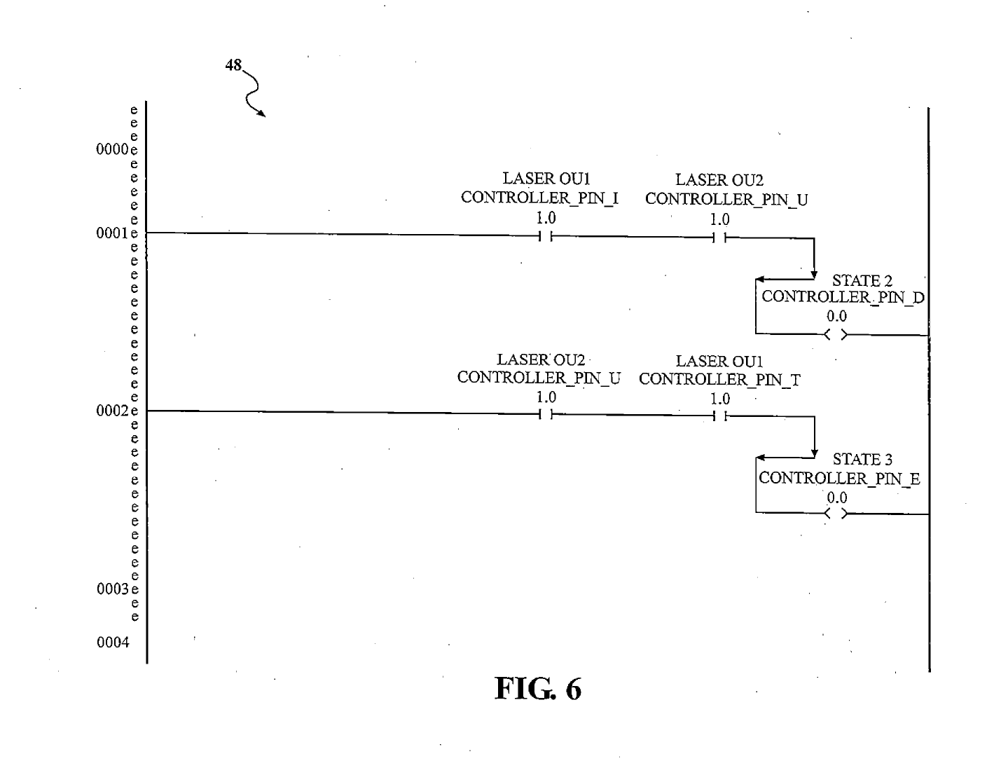

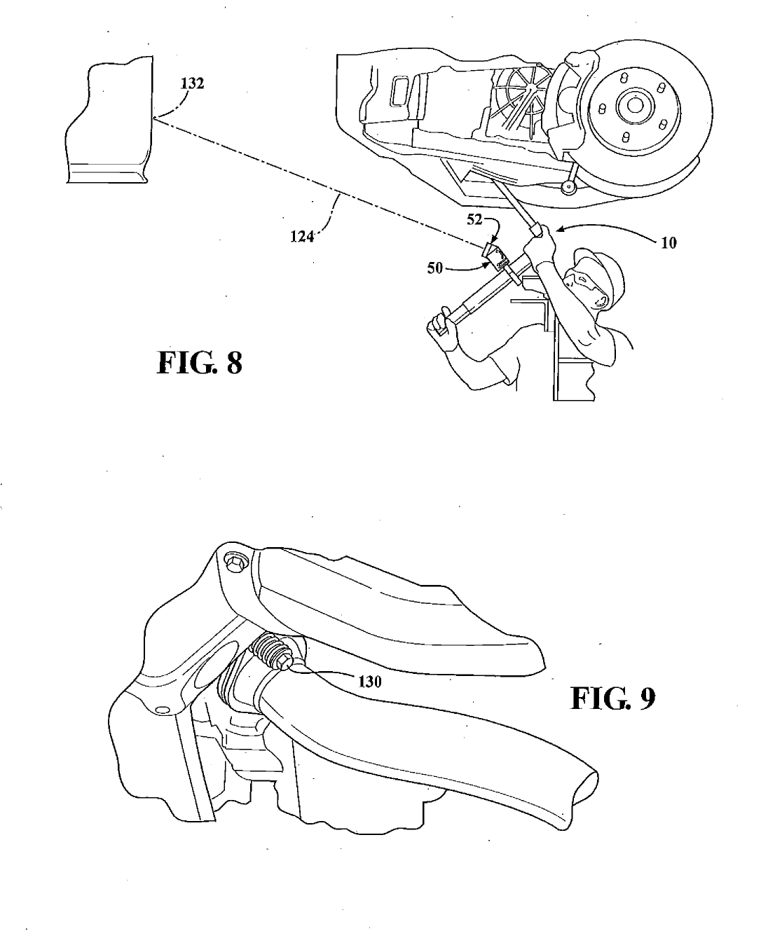

Output #1 (Laser OU1) is a condition programmed in the tool controller 20 logic shown in FIG. 6 that allows the nutrunner 10 to run the PSET #1 tool operating program. If output #1 (Laser OU1) is absent at the moment the operator depresses the trigger 46 on the nutrunner 10, the nutrunner 10 will not run. Also, during the tightening cycle, if output #1 is momentarily lost, the nutrunner 10 will stop and generate a false signal.

When the tightening cycle for joint #1 is completed, and the torque value target has been reached, a signal is sent by the tool controller 20 back to the Pokayoke system interface 106 confirming that joint #1 has been successfully completed.

The Pokayoke system 106 will now request the tool controller 20 to run PSET #2 to tighten the second joint 130 shown in FIG. 9. The laser in the housing 53 attached to the nutrunner 10 continues to emit the laser beam 124 and computes the distance to any surface the beam 124 reflects from. In the specific case of joint #2, the proper preselected surface feature is the back door 132 of the vehicle located downstream of the one in the current work station. The laser controller 120 calculates the distance measurement provided by the laser beam 124 reflecting off of the surface feature 132. When the computed distance value falls inside the range preprogrammed for the joint #2 location, output #2 signal is generated. This confirms the proper placement of the nutrunner 10 on joint #2.

The logic shown in FIG. 6 shows that a second signal is then generated by the tool controller 20 corresponding to PSET #2.

Output #2 is a condition programmed into the logic of the tool controller 20, as shown in FIG. 6, which allows the nutrunner 10 to run at PSET #2. If output #2 is absent at the moment the operator depresses the trigger 46, the nutrunner 10 will not run.

When the tightening cycle for the second joint 130 has been completed, and the target torque value has been reached, the tool controller 20 sends a signal back to the Pokayoke system 106 confirming that joint #2 has been successfully completed.

At this time, the Pokayoke system 106 has received confirmation that both joints #1 and #2 have been successfully tightened. The Pokayoke system 106 then sends a signal to the main assembly line controller 108 allowing the vehicle to advance to the next process workstation.

The same nutrunner 10 can be used for additional joints on the same vehicle as long the reference distance to be measured by the laser 52 is distinct for each separate joint.

It will also be understood that the nutrunner 10 may be used to provide the same set of work torque parameters for each of a plurality of joints, as long as a surface feature can be selected for each distinct joint or bolt head which has a completely unique or distinct distance measurement from all of the distance measurements associated with the other joints. This enables identical joints to be tightened with the same set of operating parameters, but with each distinct joint being uniquely identified along with its appropriate operating program for the nutrunner 10.

What is claimed is:

1. A method of selecting a stored tool operating program for a tool coupled to a tool controller and having a work piece engagement portion comprising:
engaging the work piece engagement member of the tool with the workpiece;
measuring, by a distance measurement device carried on the tool, a distance dimension between the distance measurement device and a surface feature dimensionally fixed with respect to the workpiece;
comparing, by a distance measurement apparatus controller, the measured distance dimension with a reference distance dimension;
transmitting by the distance measurement apparatus controller a match signal to a tool controller when the measured distance dimension equals one reference distance dimensions; and
selecting, by the tool controller, a tool operating program corresponding to the tool associated with the distance measurement apparatus output.

2. The method of claim 1 further comprising:
mounting a distance measurement sensor on the tool.

3. The improvement of claim 3 further comprising:
forming the distance measurement sensor as a laser sensor capable of emitting a laser beam from a laser source and determining a distance between the laser source and a surface feature by reflection of the laser beam off of the surface feature toward the laser source.

4. The improvement of claim 4 comprising:
adjustably mounting the laser on the tool.

5. The method of claim 1 further comprising:
forming the tool as a nutrunner having a plurality of selectable prestored torque programs, each associated with a distinct identifiable joint on a workpiece comprising:
prestoring one joint location ID with a nutrunner torque program associated with the one joint;
moving the nutrunner into an operating position engaged with the one joint; and
identifying the joint ID by matching a distance dimension from a laser sensor to a surface feature adjacent to the joint with a reference distance dimension;
the step of selecting include activating the nutrunner torque program prestored for the one joint corresponding to the a match identified between a measured distance dimension and a reference distance dimension associated with the one joint.

6. A method of operating a nutrunner having selectable prestored torque operating programs, each associated with an identifiable joint on a workpiece;
prestoring one joint location ID with a nutrunner torque program associated with the one joint;
identifying the joint ID by matching a dimension from a laser sensor to a surface feature adjacent to the one joint when the nutrunner is in an operating position engaged with the one joint; and
selected a nutrunner torque program associated for the one joint when a match is identified between a measured distance from the laser sensor to the surface feature and a reference distance associated with the one joint.

7. An apparatus for authorizing selection of one of a plurality of distinct tool operating programs each associated with one of a plurality of distinct tool operations on a workpiece comprising:
a distance measurement sensor carried on the tool;
the distance measurements sensor capable of measuring a distance dimension between the distance measurement sensor and a surface feature adjacent to the location of the tool operation on the work piece;
the distance measurement sensor transmitting an output signal when the measured distance dimension matches a reference distance dimension prestored in the laser sensor in the distance measurement apparatus;
a tool controller, upon receiving the output signal from the distance measurement sensor, selecting the one of the plurality of distinct tool operating programs associated with the one of the plurality of distinct tool operations on the work piece associated with the distance measurement for operating the tool according to the selected one tool operating program.

8. The apparatus of claim 7 further comprising:
a holder mountable on the tool; and
the distance measurement sensor mounted on the holder.

9. The apparatus of claim 8 wherein:
the distance measurement sensor is adjustably mounted on the holder.

10. The apparatus of claim 7 wherein:
the distance measurement sensor is a laser distance sensor.

11. The apparatus of claim 7 wherein:
the tool is a nutrunner.
